(19) United States
(12) Patent Application Publication
(10) Pub. No.: US 2012/0007357 A1
(43) Pub. Date: Jan. 12, 2012

(54) QUICK RELEASE CONNECTOR

(76) Inventor: Hsiu-Hsiung Liu, Jhonghe City (TW)

(21) Appl. No.: 12/832,958

(22) Filed: Jul. 8, 2010

(51) Int. Cl. F16L 37/23

(52) U.S. Cl. 285/318

(57) ABSTRACT

A quick release connector has a body, a sealing valve and an outer sleeve. The body is hollow, is fabricated as a single piece and has an external surface, an internal surface, a connecting end, a holding end, a middle, a threaded segment, an air inlet chamber, a mounting recess, an air outlet chamber, multiple ball holes, a limiting groove, an abutting flange, a returning spring, a valve ring, a sealing ring, a holding ring, multiple balls and a limiting ring. The sealing valve is movably mounted in the body, selectively abuts valve ring of the body and has an external surface, a closed end, an open end and at lease one air inlet. The outer sleeve is slidably mounted around the body and has a mounting end, a pushing end, an internal surface, a spring recess, an abutting recess, a holding recess and a pressing spring.

### BACKGROUND OF THE INVENTION

1. Field of the Invention

The present invention relates to a connector, and more particularly to a quick release connector that can be fabricated conveniently, reduced the cost of production and the fault rate of the quick release connector.

2. Description of Related Art

With reference to FIG. 8, a conventional quick release connector 70 is used in pipe connections and comprises a body 71, a socket base 72, a sealing valve 73 and an outer sleeve 74. The body 71 is hollow and has an interior and two ends. One of the ends of the body 71 is connected to an air compressor. The socket base 72 is connected to the other end of the body 71 and has an external surface, multiple ball holes 721 and multiple balls 722. The ball holes 721 are formed through the external surface of the socket base 72 at intervals. The balls 722 are held respectively in the ball holes 721 in the socket base 72. The sealing valve 73 is movably mounted in the body 71 and has an air inlet 731 communicating with the interior of the body 71. The outer sleeve 74 is slidably mounted around the socket base 72 and abuts the balls 722 of the socket base 72. A pressing spring 741 is mounted between the outer sleeve 74 and the body 71.

However, although the conventional quick release connector 70 quickly connects pipes, the body 71 and the socket base 72 are two separate elements and need to be respectively fabricated. Then, the cost and time of manufacturing the conventional quick release connector 70 is increased. Additionally, the body 71 and the socket base 72 are connected to each other by screwing, which is inconvenient to assemble. Furthermore, the pressure air of the air compressor may leak from the screwed segment between the body 71 and the socket base 72, which is dangerous in operation.

The quick release connector in accordance with the present invention mitigates or obviates the aforementioned problems.

### SUMMARY OF THE INVENTION

The main objective of the invention is to provide a quick release connector that can be fabricated conveniently, reduced the cost of production and the fault rate of the quick release connector.

The quick release connector in accordance with the present invention has a body, a sealing valve and an outer sleeve. The body is hollow, is fabricated as a single piece and has an external surface, an internal surface, a connecting end, a holding end, a middle, a threaded segment, an air inlet chamber, a mounting recess, an air outlet chamber, multiple ball holes, a limiting groove, an abutting flange, a returning spring, a valve ring, a sealing ring, a holding ring, multiple balls and a limiting ring. The sealing valve is movably mounted in the body, selectively abuts valve ring of the body and has an external surface, a closed end, an open end and at lease one air inlet. The outer sleeve is slidably mounted around the body and has a mounting end, a pushing end, an internal surface, a spring recess, an abutting recess, a holding recess and a pressing spring.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a quick release connector in accordance with the present invention;

FIG. 2 is an exploded perspective view of the quick release connector in FIG. 1;

FIG. 3 is a side view in partial section of the quick release connector in FIG. 1;

FIG. 4 is an operational exploded perspective view of the quick release connector in FIG. 1 showing a plug being inserted into the connector;

FIG. 5 is an operational side view in partial section of the quick release connector in FIG. 1 showing a plug being inserted into the connector but the connector keeping sealed;

FIG. 6 is an operational side view in partial section of the quick release connector in FIG. 1 showing a plug being further inserted into the connector and the connector being unsealed;

FIG. 7 is another operational exploded perspective view of another embodiment of a quick release connector in accordance with the present invention showing another plug being inserted into the connector; and

FIG. 8 is an exploded perspective view of a quick release connector in accordance with the prior art.

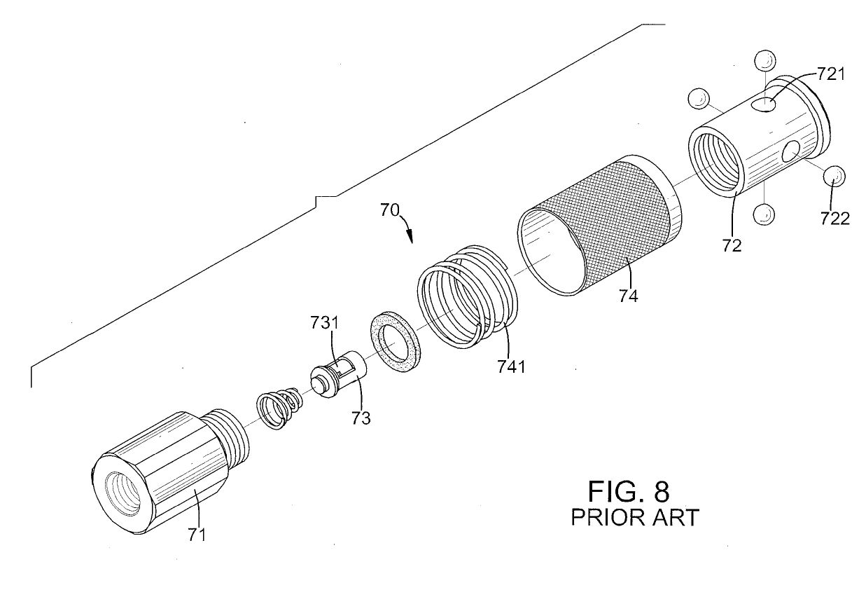

### DETAILED DESCRIPTION OF PREFERRED EMBODIMENT

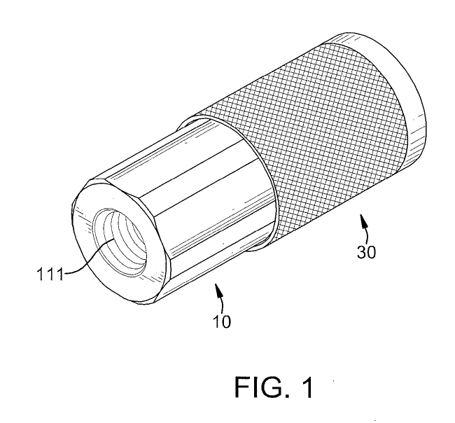

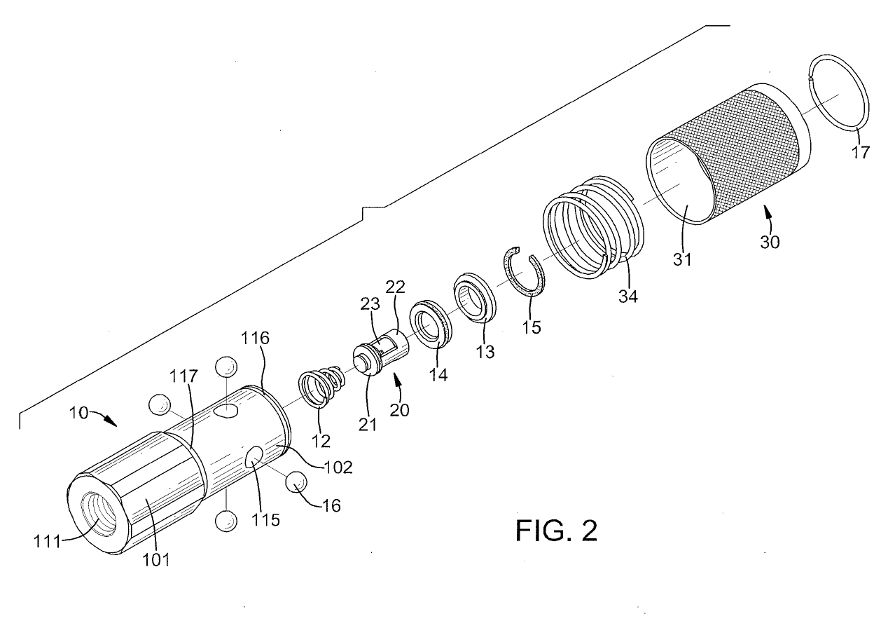

With reference to FIGS. 1 to 3, a quick release connector in accordance with the present invention comprises a body 10, a sealing valve 20 and an outer sleeve 30.

The body 10 is hollow and has an external surface, an internal surface, a connecting end 101, a holding end 102, a middle, a threaded segment 111, an air inlet chamber 112, a mounting recess 113, an air outlet chamber 114, multiple ball holes 115, a limiting groove 116, an abutting flange 117, a returning spring 12, a valve ring 14, a sealing ring 13, a holding ring 15, multiple balls 16 and a limiting ring 17.

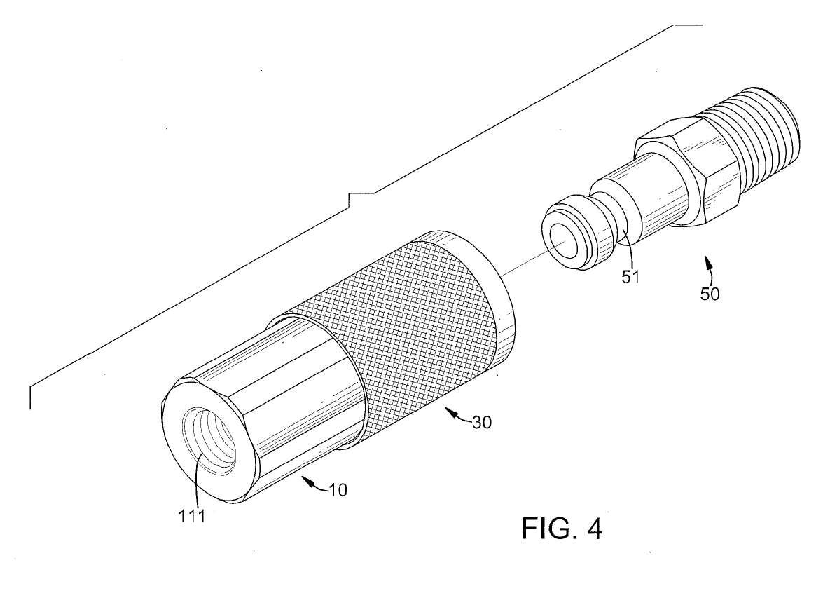

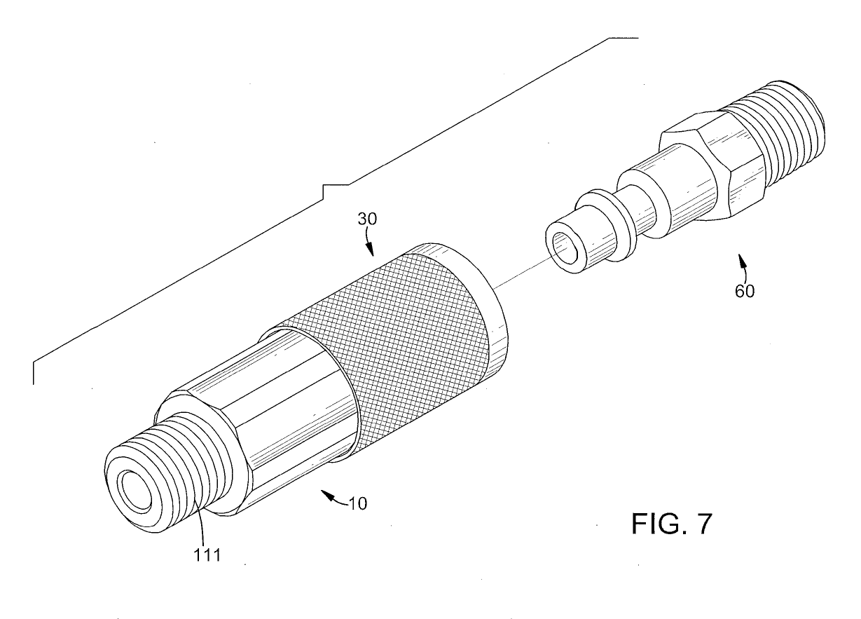

The connecting end 101 of the body 10 is connected to an air compressor. With reference to FIGS. 4 and 7, the holding end 102 of the body 10 is connected to a plug 50, 60. The thread segment 111 is formed in the internal surface of the body 10 near the connecting end 101 or is formed on the external surface of the body 10 near the connecting end 101, and is screwed with the air compressor. The air inlet chamber 112 is formed in the body 10 near the connecting end 101 and has a diameter. The mounting recess 113 is formed in the body 10 between the ends, communicates with the air inlet chamber 112 and has an internal surface, a protruding face and a diameter larger than the diameter of the air inlet chamber 112. The protruding face is formed on the internal surface of body 10 between the air inlet chamber 112 and the mounting recess 113.

The air outlet chamber 114 is formed in the body 10 near the holding end 102 and communicates with the mounting recess 113 and the air inlet chamber 112. The ball holes 115 are formed through the external surface of the body 10 at intervals near the holding end 102, are arranged in a circle around the body 10 and communicate with the air outlet chamber 114. The limiting groove 116 is formed around the external surface of the body 10 at the holding end 102. The abutting flange 117 is formed on the external surface of the body 10 near the middle.

The returning spring 12 is mounted in the air inlet chamber 112 of the body 10 and has two ends, one of the ends abuts the internal surface of the body 10 near the connecting end 101. The valve ring 14 is mounted in the mounting recess 113 of the body 10 and abuts against the protruding face of the mounting recess 113. Preferably, the valve ring 14 may have an O-ring mounted around an external surface of the valve ring 14. The sealing ring 13 is mounted in the mounting recess 113 of the body 10 between the valve ring 14 and the air outlet chamber 114. The holding ring 15 is securely mounted in the mounting recess 113 of the body 10 to hold the valve ring 14 and the sealing ring 13 securely in the mounting recess 113. The balls 16 are respectively held in the ball holes 115 in the body 10. The limiting ring 17 is mounted in the limiting groove 116 of the body 10.

The sealing valve 20 is movably mounted in the body 10, selectively abuts valve ring 14 of the body 10 and has an external surface, a closed end 21, an open end 22 and at lease one air inlet 23. The closed end 21 of the sealing valve 20 is mounted in the air inlet chamber 112 of the body 10 via the sealing ring 13 and the valve ring 14 and abuts the other end of the returning spring 12 of the body 10. The open end 22 of the sealing valve 20 is mounted in the air outlet chamber 114 of the body 10 and communicates with the air outlet chamber 114. The at least one air inlet 23 is formed radially through the external surface of the sealing valve 20 near the closed end 21 and selectively communicates with the air inlet chamber 112 or the air outlet chamber 114.

The outer sleeve 30 is slidably mounted around the body 10 and has a mounting end, a pushing end, an internal surface, a spring recess 31, an abutting recess 32, a holding recess 33 and a pressing spring 34. The mounting end of the outer sleeve 30 is mounted around the body 10 near the middle. The pushing end of the outer sleeve 30 is mounted around the holding end 102 of the body 10. The spring recess 31 is formed in the internal surface of the outer sleeve 30 near the mounting end around the body 10. The abutting recess 32 is formed in the internal surface of the outer sleeve 30 at the pushing end and abuts the limiting ring 17 of the body 10 to hold the outer sleeve 30 on the body 10. The holding recess 33 is formed in the internal surface of the outer sleeve 30 near the abutting recess 32 and selectively abuts the balls 16. The pressing spring 34 is mounted around the body 10 between the abutting flange 117 and the spring recess 31 to make the internal surface of the outer sleeve 30 between the spring recess 31 and the holding recess 33 abutting the balls 16 of the body 10.

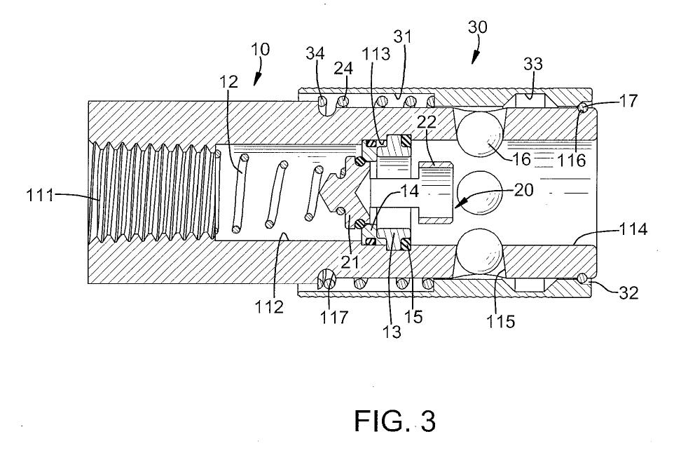

With reference to FIG. 3, when the connecting end 101 of the body 10 is connected to an air compressor and the quick release connector as described is not connected with a plug, the closed end 21 of the sealing valve 20 abuts against the valve ring 14 and closes the at least one air inlet 23 of the sealing valve 20 by a force of the returning spring 12. The pressured air from the air compressor through the air inlet chamber 112 of the body 10 is blocked by the closed end of the sealing valve 20, the valve ring 14 and the sealing ring 13 of the body 10 and is kept from leaking.

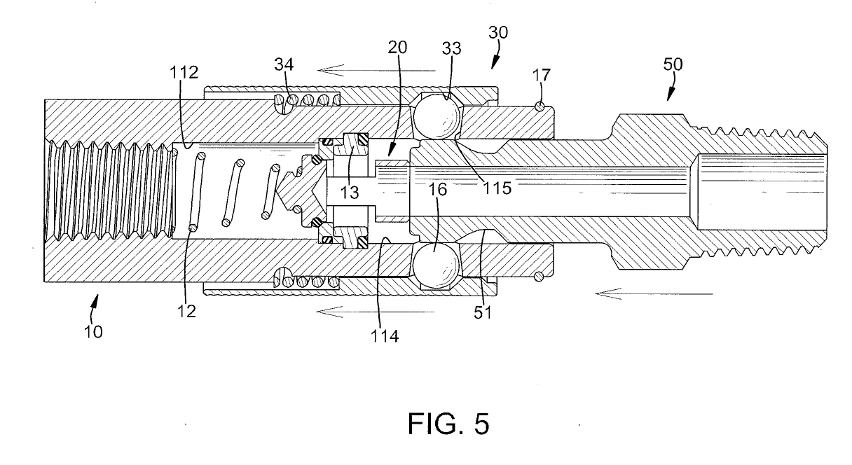

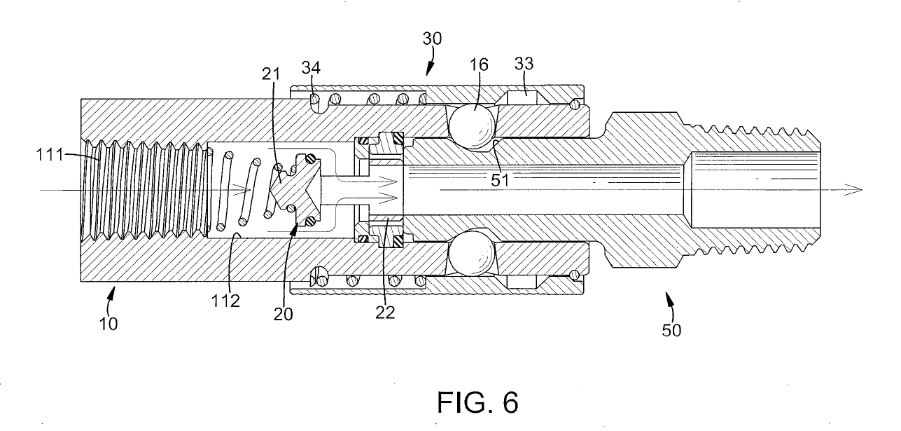

With reference to FIGS. 4 and 5, when a plug 50 with an annular engaging recess 51 connected to a tool is inserted into the air outlet chamber 114 of the body 10 via the holding end 102, the outer sleeve 20 is pushed forward to the connecting end 101 of the body 10 to press the pressing spring 34. Then the holding recess 33 aligns and communicates with the ball holes 115 of the body 10. With reference to FIG. 6, when the engaging recess 51 of the plug 50 aligns with the ball holes 115 of the body 10, unloosing the outer sleeve 30 and the outer sleeve 30 moves to the original position by the force of the pressing spring 34. Then, the balls 16 will retract into the engaging recess 51 of the plug 50 by the internal surface of the outer sleeve 30 between the spring recess 31 and the holding recess 33 to hold the plug 50 firmly with the body 10.

At the same time, when the plug 50 is held on the body 10 by the balls 16 and the engaging recess 51, the plug 50 abuts and pushes against the open end 22 of the sealing valve 20 to move relative to the valve ring 14 and the sealing ring 13 of the body 10 and to press the returning spring 12. Then the closed end 22 of the sealing valve 20 leaves the position to allow the pressured air to flow into the plug 50 via the at least one air inlet 23 of the sealing valve 20. Then, the pressured air will flow into the tool that is connected with the plug 50 via the body 10 and the plug 50.

When a user wants to separate the plug 50 from the body 10 of the quick release connector in accordance with the present invention, the user needs to push the outer sleeve 30 to move to the connecting end 101 of the body 10 so that the balls 16 escape from the engaging recess 51 of the plug 50 and moves into the holding recess 33. Then, the plug 50 can be separated from the holding end 102 of the body 10 easily. When the plug 50 separates from the body 10, the sealing valve 20 moves back the original position by the force of the returning spring 12 to allow the closed end 21 of the sealing valve 20 abutting with the valve ring 14 and the sealing ring 13. In addition, with reference to FIG. 7, another kind of the plug 60 can be held firmly with the body 10 by the balls 16.

The body 10 is fabricated as a single piece and this can reduce the cost and time of manufacturing and assembling the quick release connector in accordance with the present invention. In addition, the pressure air of the air compressor can not leak from the body 10 and this can prevent the user from getting hurt during connecting the plug 50, 60 with the body 10 of the quick release connector.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A quick release connector comprising:
a body being hollow, being fabricated as a single piece and having
an external surface;
an internal surface;
a connecting end being adapted to connect with an air compressor;
a holding end being adapted to connect with a plug;
a middle;
an air inlet chamber formed in the body near the connecting end and having a diameter;
a mounting recess formed in the body between the ends, communicating with the air inlet chamber and having
an internal surface;
a protruding face formed on the internal surface of body between the air inlet chamber and the mounting recess; and
a diameter being larger than the diameter of the air inlet chamber;
an air outlet chamber formed in the body near the holding end and communicating with the mounting recess and the air inlet chamber;
multiple ball holes formed through the external surface of the body at intervals near the holding end, arranged in a circle around the body and communicating with the air outlet chamber;
a returning spring mounted in the air inlet chamber of the body and having two ends, one of the ends abutting the internal surface of the body near the connecting end; and
multiple balls respectively held in the ball holes in the body;
a sealing valve movably mounted in the body and having
an external surface;
a closed end mounted in the air inlet chamber of the body and abutting the other end of the returning spring of the body;
an open end mounted in the air outlet chamber of the body and communicating with the air outlet chamber; and
at lease one air inlet formed radially through the external surface of the sealing valve near the closed end and selectively communicating with the air inlet chamber or the air outlet chamber; and
an outer sleeve slidably mounted around the body and having
a mounting end mounted around the body near the middle;
a pushing end mounted around the holding end of the body;
an internal surface;
a spring recess formed in the internal surface of the outer sleeve near the mounting end around the body;
a holding recess formed in the internal surface of the outer sleeve near the abutting recess and selectively abutting the balls; and
a pressing spring mounted around the body between the middle of the body and the spring recess to make the internal surface of the outer sleeve between the spring recess and the holding recess abutting the balls of the body.

2. The quick release connector as claimed in claim 1, wherein
the body has
a limiting groove formed around the external surface of the body at the holding end; and
a limiting ring mounted in the limiting groove of the body; and
the outer sleeve has an abutting recess formed in the internal surface of the outer sleeve at the pushing end and abutting the limiting ring of the body to hold the outer sleeve on the body.

3. The quick release connector as claimed in claim 2, wherein
the body has an abutting flange formed on the external surface of the body near the middle; and
the pressing spring is mounted around the body between the abutting flange and the spring recess.

4. The quick release connector as claimed in claim 3, wherein
the body has
a valve ring mounted in the mounting recess of the body and abutting with the protruding face of the mounting recess; and
a sealing ring mounted in the mounting recess of the body between the valve ring and the air outlet chamber;
the sealing valve is movably mounted in the body and selectively abuts valve ring of the body; and
the closed end of the sealing valve is mounted in the air inlet chamber of the body via the sealing ring and the valve ring.

5. The quick release connector as claimed in claim 4, wherein the body has a holding ring securely mounted in the mounting recess of the body to hold the valve ring and the sealing ring securely in the mounting recess.

6. The quick release connector as claimed in claim 5, wherein the body has a thread segment formed in the internal surface of the body near the connecting end to screw with an air compressor.

7. The quick release connector as claimed in claim 5, wherein the body has a thread segment formed on the external surface of the body near the connecting end to screw with an air compressor.

8. The quick release connector as claimed in claim 1, wherein
the body has
a valve ring mounted in the mounting recess of the body and abutting with the protruding face of the mounting recess; and
a sealing ring mounted in the mounting recess of the body between the valve ring and the air outlet chamber;
the sealing valve is movably mounted in the body and selectively abuts valve ring of the body; and
the closed end of the sealing valve is mounted in the air inlet chamber of the body via the sealing ring and the valve ring.

9. The quick release connector as claimed in claim 8, wherein the body has a holding ring securely mounted in the mounting recess of the body to hold the valve ring and the sealing ring securely in the mounting recess.
